(19) United States
(12) Patent Application Publication
(10) Pub. No.: US 2025/0327683 A1
(43) Pub. Date: Oct. 23, 2025

(54) Method and System for Generative AI Navigational Assistance

(71) Applicant: Salesforce, Inc., San Francisco, CA (US)

(72) Inventor: Charles Hart ISAACS, San Francisco, CA (US)

(73) Assignee: Salesforce, Inc., San Francisco, CA (US)

(21) Appl. No.: 18/643,233

(22) Filed: Apr. 23, 2024

(51) Int. Cl. G01C 21/36

(52) U.S. Cl. CPC G01C 21/3641; G01C 21/3679

(57) ABSTRACT

Described herein are techniques and mechanisms for geographic routing. A database system may store data records corresponding with user accounts and including historical routing information characterizing geographic routes determined in association with the user accounts. A communication interface may receive a request from a remote computing device authenticated to a user account and identifying an initial geographic location and a terminal geographic location. A geographic routing engine may determine a route including turn-by-turn instructions for moving from the initial geographic location to the terminal geographic location. A generative language model interface may complete a navigation prompt to include novel text identifying supplemental route information. A user interface generation interface may transmit an instruction to the remote computing device to present a user interface that includes the turn-by-turn instructions and some or all of the supplemental route information.

### FIELD OF TECHNOLOGY

This patent application relates generally to database systems, and more specifically to the use of database systems and generative artificial intelligence to aid with navigation assistance.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. For example, users may interact with navigation services implemented in cloud comp environments to determine a route from a given starting point to a destination point. Such interactions may be conducted via any of various types of devices, such as mobile devices and/or vehicle infotainment systems. Given the prevalence of navigation services as a cloud computing application, improved techniques for integrating navigation services with database systems are desired.

### BRIEF DESCRIPTION OF THE DRAWINGS

The included drawings are for illustrative purposes and serve only to provide examples of possible structures and operations for the disclosed inventive systems, apparatus, methods, and computer program products for generative artificial intelligence navigational assistance. These drawings in no way limit any changes in form and detail that may be made by one skilled in the art without departing from the spirit and scope of the disclosed implementations.

FIG. 1 illustrates a geographic routing overview method, performed in accordance with one or more embodiments.

FIG. 2 illustrates one example of a computing services environment, configured in accordance with one or more embodiments.

FIG. 3 illustrates a method of processing a route request, performed in accordance with one or more embodiments.

FIG. 4 illustrates a method of determining one or more routes, performed in accordance with one or more embodiments.

FIG. 5 illustrates a method of selecting a route, performed in accordance with one or more embodiments.

FIG. 6 illustrates a method of tuning a navigational generative language model, performed in accordance with one or more embodiments.

FIG. 7 shows a block diagram of an example of an environment that includes an on-demand database service configured in accordance with some implementations.

FIG. 8A shows a system diagram of an example of architectural components of an on-demand database service environment, configured in accordance with some implementations.

FIG. 8B shows a system diagram further illustrating an example of architectural components of an on-demand database service environment, in accordance with some implementations.

FIG. 9 illustrates one example of a computing device, configured in accordance with one or more embodiments.

### DETAILED DESCRIPTION

Techniques and mechanisms described herein provide for a database system that facilitates guided navigation. A device associated with a user account may send a request for navigation guidance to travel from one geographic location to another. The system may then determine one or more candidate routes, as well as information for points of interest along the route. The route information may include turn-by-turn navigation instructions, natural language about points of interest along the way, and the like. The routing information may be generated using one or more artificial intelligence models, and may be tuned and/or parameterized to reflect the preferences and feedback of a user or users.

Consider the example of Alexandra, a user of navigation systems. When using conventional navigation systems, Alexandra faces the problem of not readily being able to select or change a route in a way that reflects her various implicit and explicit preferences. Complicating matters further, her preferences may change over time depending on environmental changes such as the weather, road conditions, traffic, and the like. In contrast to conventional techniques, when using techniques and mechanisms described here a generative artificial intelligence navigation system can generate routing information that accommodates her various preferences. For example, the system may suggest routes based on historical data for Alexandra and/or other users. As another example, if Alexandra wants to change the route to a more scenic option, to avoid inclement weather, or to include one or more points of interest, Alexandra may indicate these new preferences to the navigation system and the generative AI navigation system can incorporate them when planning the route. As yet another example, a rideshare service driver may request routing information to integrate the preferences of the rideshare user into the route.

Although artificial intelligence models have been applied to a range of applications, various technical challenges have limited their application to geographic routing problems. Although a routing request to travel from one geographic location to another may seem straightforward, in practice a variety of routes may be possible, and the requesting user may not necessarily want a route that, for example, minimizes transit time. Instead, a user may have idiosyncratic requests and preferences that may guide the user's preferred route. Such requests and preferences may be poorly addressed by conventional approaches that employ a singular artificial intelligence model to determine a route between two points. Moreover, conventional approaches for determining routing information rely on a single data source (e.g., map information) common to all users and provide only a simple response (e.g., a route from a source location to a destination location. Additionally, conventional approaches for addressing geographic routing problems do not take into account user feedback, for instance feedback that indicates user satisfaction with previously provided routing information.

In contrast to these conventional approaches, various embodiments described herein provide for integrating multiple sources of information with a multi-model process for determining multifaceted routing information to provide to the user in a manner that adapts over time to user feedback. The system may employ a multifaceted artificial intelligence model and/or more than one artificial intelligence model working in concert to address the complexity of routing requests. Moreover, various sources of information may be used to inform the determination of the routing information. Further, a user may be provided with not only turn-by-turn instructions but also textual explanation, selectable options, and other such supplemental information. Additionally, a user can provide feedback as to the routing information to improve responses to future routing requests.

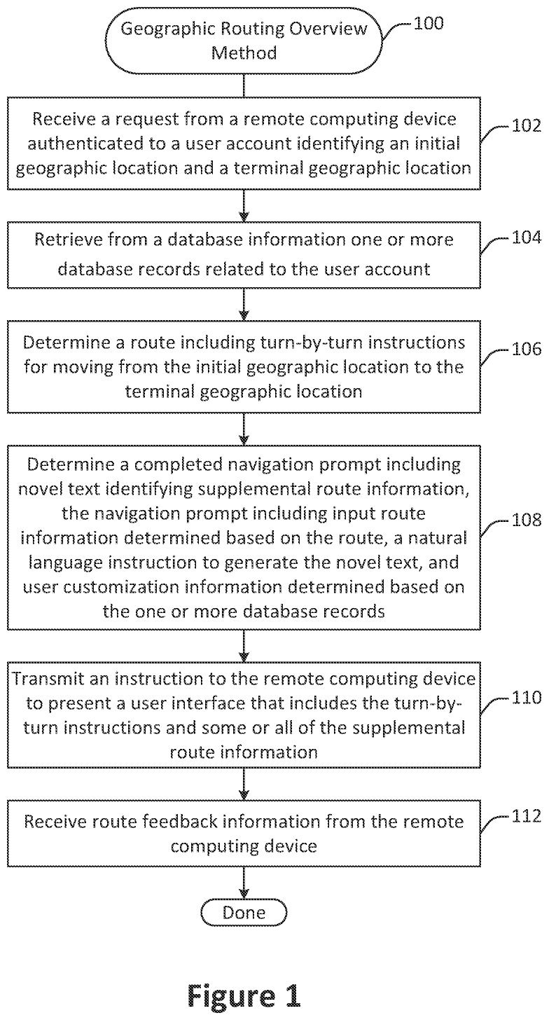

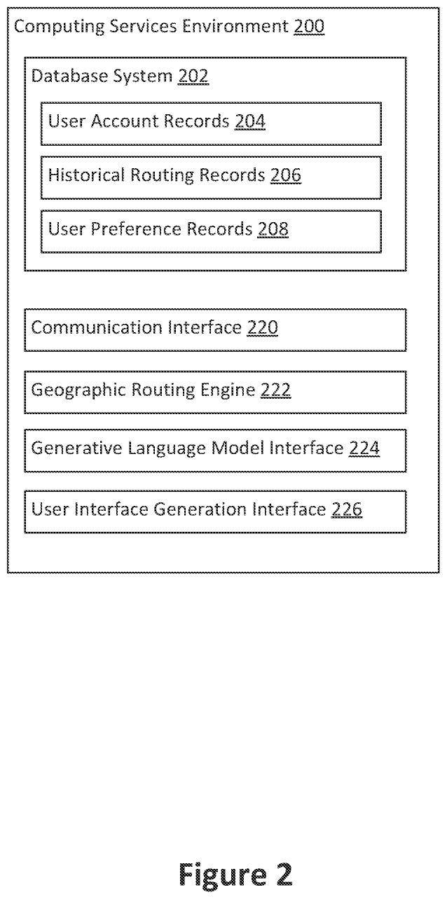

FIG. 1 illustrates a geographic routing overview method 100, performed in accordance with one or more embodiments. According to various embodiments, the method 100 may be performed on any suitable computing device. For instance, the method 100 may be performed at one or more components in a computing services environment. Various details regarding such an example of such an environment are discussed with respect to FIG. 2.

A request is received at 102 identifying an initial geographic location and a terminal geographic location. The request may be received from a remote computing device authenticated to an account in a database system. In some embodiments, the remote computing device may be a mobile computing device such as a mobile phone. Alternatively, the remote computing device may be an infotainment system within a vehicle.

In some embodiments, the request may be transmitted via an application procedure interface and may indicate a desire to determine routing information for physically moving from the initial geographic location to the terminal geographic location. For instance, the initial and terminal geographic locations may be different locations within a city, country, or other geographic region.

According to various embodiments, the initial and/or terminal geographic locations may be specified via geocoordinates such as latitude and longitude. Alternatively, or additionally, the initial and/or terminal geographic locations may be specified by another type of location identifier. For instance, one or both locations may be identified by name (e.g., Salesforce Tower).

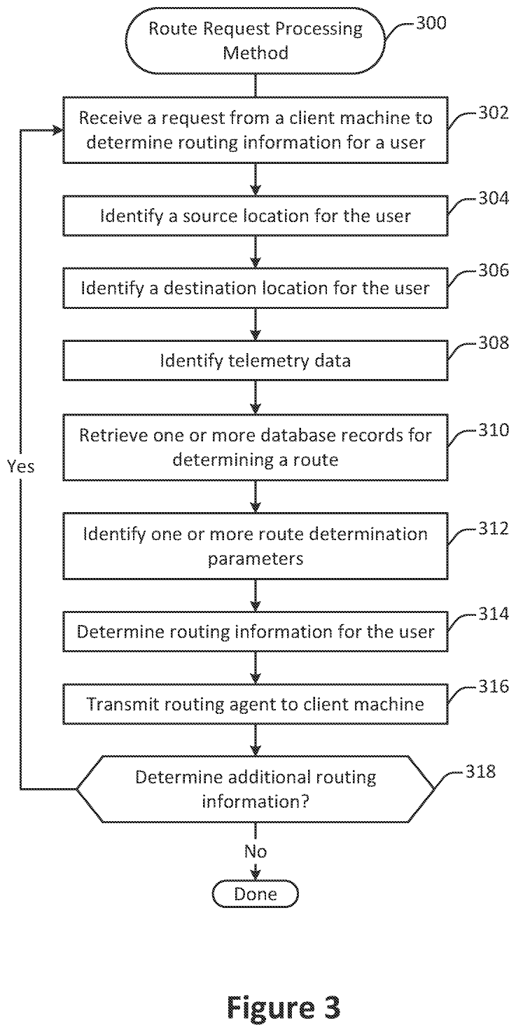

One or more database records related to the user account are retrieved from the database system at 104. According to various embodiments, the one or more database records may include any information suitable for facilitating the determination of routing information in response to the request. For example, the one or more database records may include implicitly determined and/or explicitly specified user preference data. As another example, the one or more database records may include previously provided routing information and/or feedback provided by the user in response to previously provided routing information. As yet another example, the one or more database records may include previously determined telemetry data collected for a vehicle or device associated with the user. Additional details regarding the receipt of a request to determine a route and/or the retrieval of database records for responding to the routing request are discussed with respect to the method 300 shown in FIG. 3.

One or more routes may be determined at 106 for moving from the initial geographic location to the terminal geographic location. In some embodiments additional data may be used to aid with the route generation/determination process. In some embodiments, route metadata may also be determined. For example, associated route metadata may include turn-by-turn instructions. As another example, associated route metadata may include route duration.

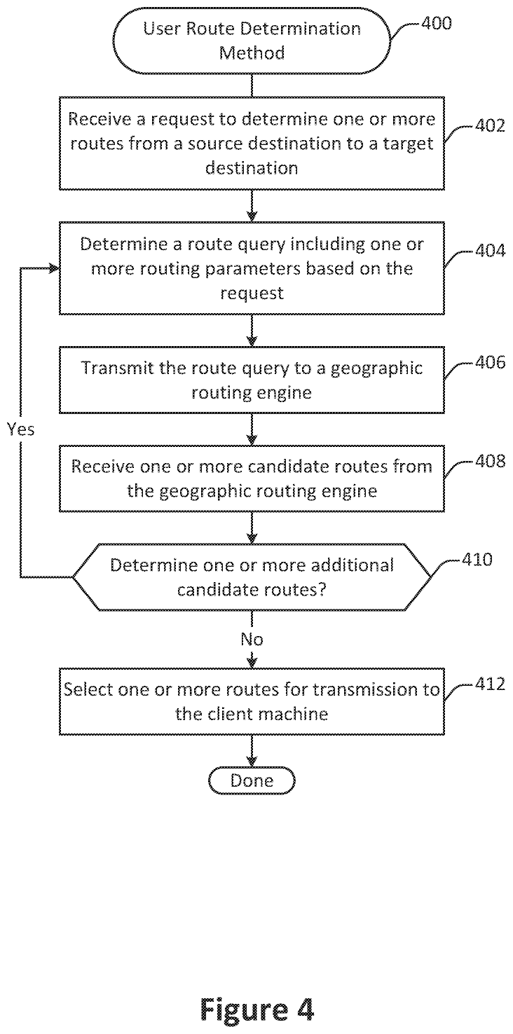

One or more routing parameters may be used to determine candidate routes used by the geographic routing engine. According to various embodiments, the one or more routing parameters may include any information suitable for facilitating the determination of the route, including implicitly determined and/or explicitly specified user preferences. For example, the system may take into account historical data such as user feedback, user preferences, past routing information, forecasted data such as weather conditions, data regarding traffic conditions, user instructions (e.g., Avoid Tolls), and the like. Additional details regarding the route determination method and parameters used to determine the route are discussed with respect to the method 400 in FIG. 4.

A navigation prompt is determined at 108. According to various embodiments, the navigation prompt may be determined by filling one or more fillable portions of a navigation prompt template with information from one or more sources of information. Such sources of information may include implicitly and or/explicitly specified sources information. For example, implicitly specified user preference data may include, but is not limited to, the associated users' preference records, historical routing records, and/or route feedback records. As another example, explicitly specified information may include user preferences about the route itself (e.g., Avoid tolls). As yet another example, the navigation prompt may be influenced by the input route information based on the route (e.g., the destination location and/or the source location).

Examples of natural language instructions that may be included in navigation prompts and/or other prompts described herein are as follows:
The natural language instruction “Give me a comma separated list of points of interest along the way to Destination <DESTINATION> maximizing <SUBJECT>.” may be used to instruct a generative language model to generate a list of points of interest, for instance as geographic coordinates, to provide into a navigation mapping application.
The natural language instruction “Give me a comma separated list of <USER'S STORED LIST OF INTERESTS> in this <AREA> traveling to DESTINATION.” may be used to instruct a generative language model to generate a list of a user's stored points of interest, for instance as geographic coordinates, to provide into a navigation mapping application.
The natural language instruction “Give me a comma separated list of <HOMES THAT ARE AVAILABLE FOR SALE> while traveling to <DESTINATION>.” may be used to instruct an artificial intelligence system to generate a list of homes for sale along a route, for instance as geographic coordinates, which are provided as suggestions when the user enters a geographic area near the homes.
The natural language instruction “I want to eat around <TIME PREFERENCE> and am going to <DESTINATION>. Find me a <FOOD TYPE> along the way.” may be used to identify nearby restaurant locations that correspond with a food preference within a geographic area.
The natural language instruction “Give me a tour of <CITY> with the top places to visit and a time limit of <MINUTES>.” may be used to determine a route through a city.
The natural language instruction “Give me a route having <CHARACTERISTICS> within a <GEOGRAPHIC AREA>.” may be used to determine a route that exhibits one or more characteristics.
The natural language instruction “Give me a route from <SOURCE> to <DESTINATION> reflecting these preferences: <PREFERENCES>.” may be used to determine a route that exhibits one or more characteristics.

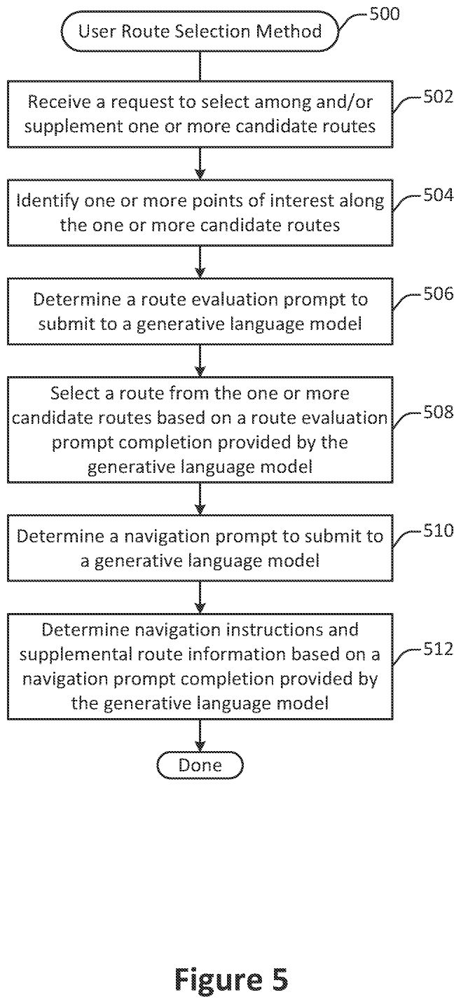

According to various embodiments, information determined by a completed navigation prompt may be further refined, for instance via further evaluation by a generative language model. For instance, the route evaluation prompt may include an instruction to include a coffee shop that is within 15 mins of the destination, and the evaluation prompt may score one or more routes determined by the navigation prompt on this basis. Additional details regarding the determination of routing information are discussed with respect to the method 500 shown in FIG. 5.

An instruction is transmitted to the remote computing device at 110 to present a user interface. According to various embodiments, information included in the user interface presented to the user may include any suitable output associated with the routing response. The instruction may be generated by a user interface generation interface at a computing services environment which transmits instructions suitable to the device on which the information is to be displayed.

According to various embodiments, the information presented on the user interface may include, but is not limited to, route data, route metadata, and/or some or all of the supplemental route information. For example, route data presented in the user interface may include turn-by-turn instructions. Such turn-by-turn instructions may be presented visually, audible (e.g., via speech synthesis), or both. As another example, the information presented may include supplemental information such as descriptions of one or more points of interest. For instance, supplemental route information sent to the client machine may be formatted as shown in the example following:
supplemental_route_information object {
   “locations_of_interest”[{
      “name”: “Salesforce Tower”,
      “coordinates”: {“latitude”: 37.789778, “longitude”: −122.396944},
      “distance”: “3.1 miles”
      “description”: “Tallest building in San Francisco, home to various tech companies and offering an observation deck with panoramic views of the city.”,
      “category”: “Landmark”},
         {//other locations of interest . . . }]}

According to various embodiments, the user interface may be presented via one or more of a variety of mediums of communication. For example, the user interface may include one or more of visual, textual, audio, vibrational, sensory, spatial, and holographic means of communication. For instance, the user interface may include a visual map with turn-by-turn directions and spoken alerts along the map about road conditions. As another example, the user interface may use historical data to create a heatmap for the user interface. For instance, if the user prompts the navigation system to show where to find a certain type of users (e.g., potential customers), the user interface generation of the navigation system may return a heatmap of the concentration of users. Additional details regarding the user interface generation are discussed with respect to the user interface generation interface at 226, and the method 500 in FIG. 5.

The route feedback information is received from the remote computing device at 112. According to various embodiments, route feedback information may include user input indicating a user response (e.g., thumbs up or down, a number of stars, etc.) regarding a user impression for the routing information. The route feedback data may be collected at any suitable time during the planning phase, mid-route, and/or after the route is completed. The route feedback received at 112 may be stored in the database system and then used later, for instance during the route planning process for subsequent routes.

In some embodiments, route feedback may include telemetry data collected from one or more devices used by the associated user during the route. For example, telemetry data collected may include vehicle location, speed, or other such data. Such telemetry data may indicate implicitly whether the user agreed with the suggested routing information.

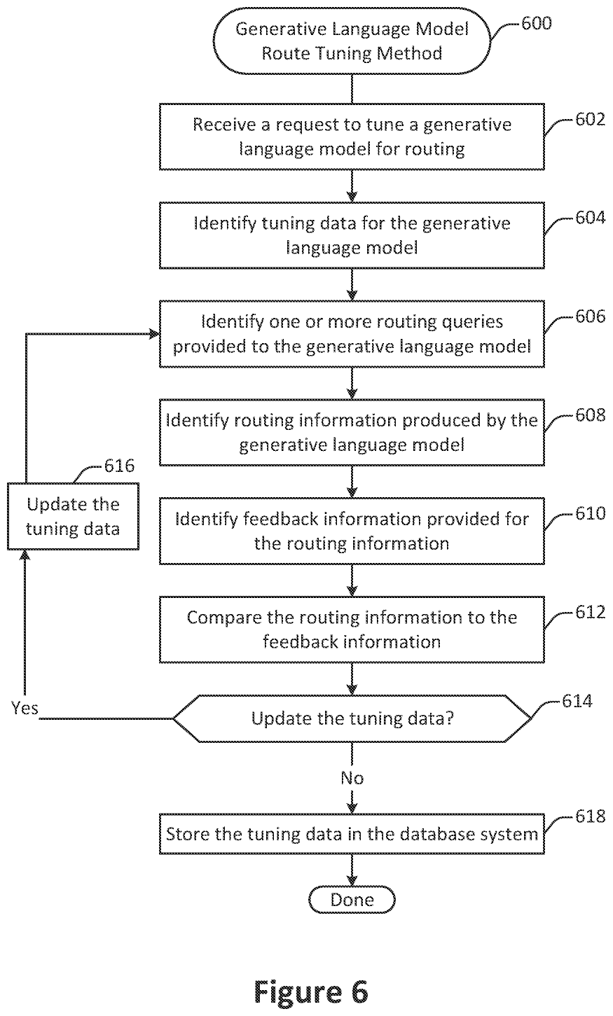

In some implementations, the user provided feedback may also be used to improve the route recommendation system for future routes. For example, the user provided feedback may also be used to update a users' route preferences. As another example, the route feedback may be used for parameter tuning during the planning phase of future routes. As yet another example, the route feedback information may include the music playing during the ride, and the recommendation system may suggest listening to similar music in future rides if the user gave positive route feedback. Additional details regarding route feedback information and/or the use of route feedback information are discussed with respect to the method 600 shown in FIG. 6.

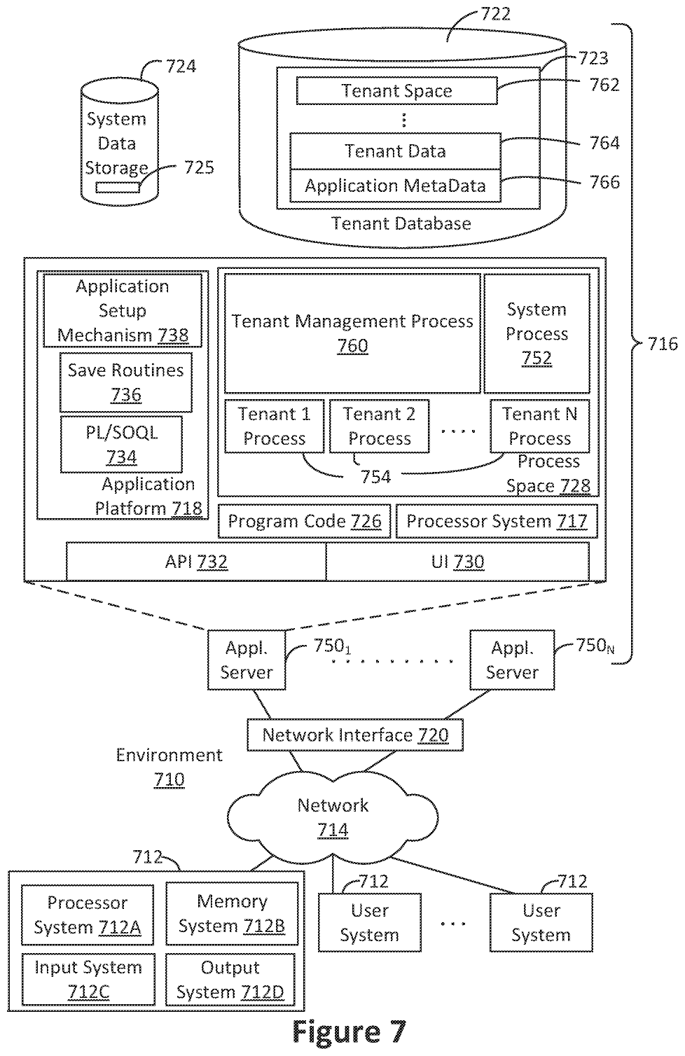

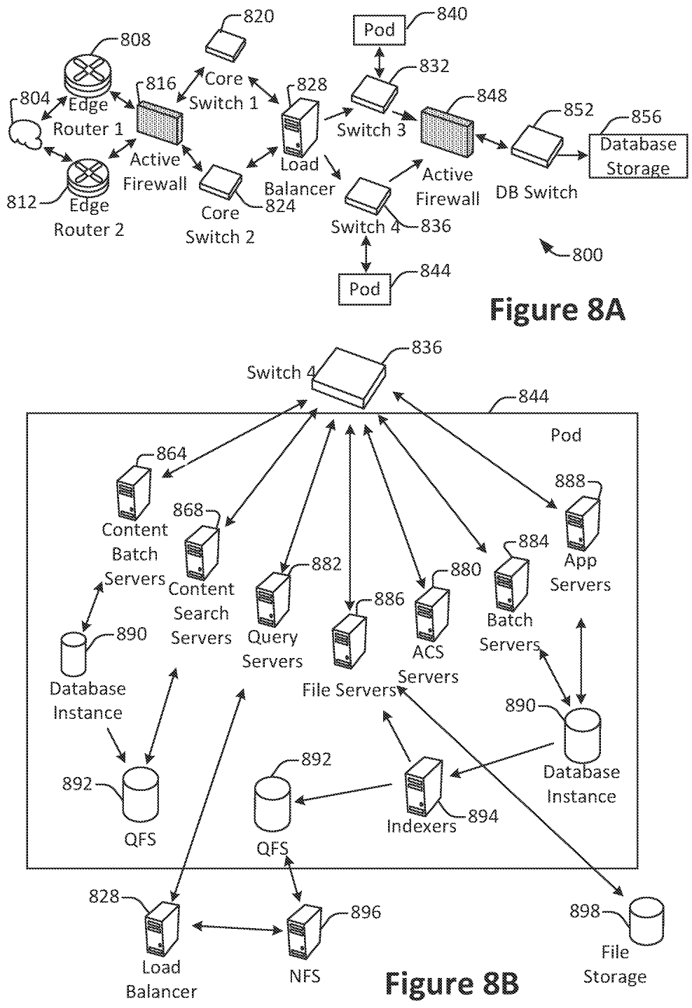

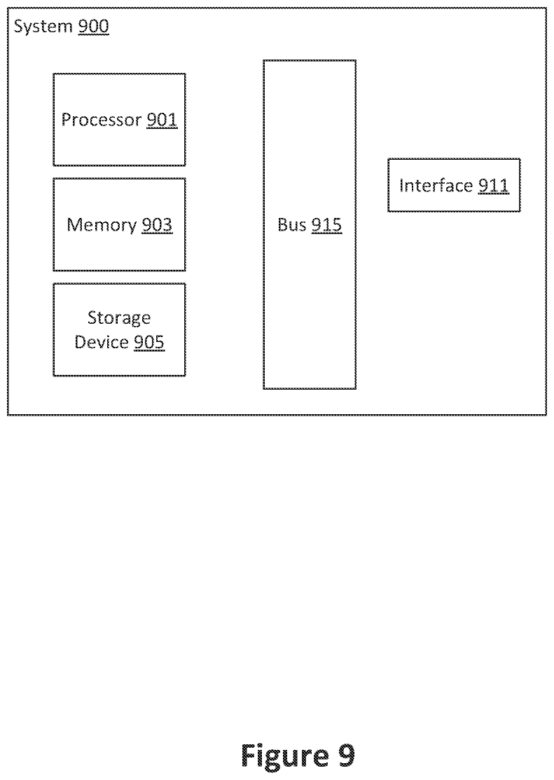

FIG. 2 illustrates one example of a computing services environment 200. According to various embodiments, the computing services environment 200 includes a database system 202, a communication interface 220, a geographic routing engine 222, a generative language model interface 224, and a user interface generation interface 226. The database system 202 stores information including user account records 204, historical routing records 206, and user preference records 208. Additional details regarding various elements that may be included in a computing services environment are discussed with respect to FIG. 7, FIG. 8A, FIG. 8B, and FIG. 9.

In some implementations, the database system 202 facilitates storing and retrieving relevant records to facilitate determining responses to requests for geographic routing information. The database system 202 may store information corresponding with various entities accessing computing services via the computing services environment 200. For instance, the database system 202 may store customer relations management (CRM) records for various organizations. Additional details regarding the types of data that may be stored in a database system are discussed with respect to FIG. 7, FIG. 8A, FIG. 8B, and FIG. 9.

According to various embodiments, the user account records 204 may include any records that help the computing services environment determine routing information. For example, the user account records 204 may include user-specific metadata information, information about one or more roles associated with the user account, and/or other user-specific data and/or metadata.

According to various embodiments, the historical routing records 206 may include information about previous routing requests transmitted in association with the user account and processed by the computing services environment 200. For example, the historical routing records 206 may include metadata about routes previously provided to the user account, and response times for responses provided to the user account. As another example, the historical routing records 206 may include information pertaining to feedback responses provided by the user in response to previously provided routing information.

According to various embodiments, the historical routing records 206 may include historical telemetry data collected from one or more devices in association with the user account. For example, the historical routing records 206 may include telemetry data from the associated user's mobile device and/or vehicle collected before, during, or after the route is traversed.

According to various embodiments, the user preference records 208 may include any information identifying user preferences related to geographic routing. For example, the user preference records 208 may identify one or more types of locations that a user associated with the user account prefers or disprefers to visit. As another example, the user preference records 208 may identify feedback information provided by the user in response to visiting a location and/or in response to routing information provided by the computing services environment 200.

In some implementations, the database system 202 may perform one or more optimization operations to improve the services provided to the user. For example, the database system 202 may temporarily cache a subset of data required to generate a response to the user to improve the response time.

According to various embodiments, the communication interface at 220 may be configured to receive a request for routing information from a remote computing device authenticated to a user account. The request may identify an initial geographic location and a terminal geographic location. Additional details regarding the receipt and processing of such requests are discussed throughout the application as filed.

In some embodiments, the geographic routing engine at 222 may be configured to determine a route from the initial geographic location to the terminal geographic location. The route may include turn-by-turn instructions for moving from the initial geographic location to the terminal geographic location. The routing information may be determined based on one or more of the user account records 204, the historical routing records 206, and/or the user preference records 208. Additional details regarding operations performed by the geographic routing engine are discussed with respect to the method 400 in FIG. 4.

According to various embodiments, the generative language model interface at 224 facilitates interactions between the computing services environment of 200 and one or more generative language models. For example, the generative language model interface may facilitate interactions with any of various generative language models, which may be selected based on their suitability for particular tasks. As another example, the generative language model interface may aggregate results from a plurality of artificial intelligent models to provide the optimal results. As yet another example, the generative language model interface may interface with one or more speech detection and/or speech generation models. Additional details regarding operations performed in conjunction with the generative language model interface are discussed with respect to the method 500 in FIG. 5, and the method 600 in FIG. 6.

In some embodiments, the user interface generation interface at 226 enables the computing services environment of 200 to interact with a plurality of user interface generation services. The user interface generation interface generates instructions to a one or more of interfaces that suits the device and/or context in which the user receives the information. Examples of user interfaces at which the routing information may be displayed include, but are not limited to one or more visual (e.g., display screen), textual, audio, vibrational, sensory, spatial, and holographic communication devices. Additional details regarding the operation of the user interface generation interface are discussed with respect to the method 100 in FIG. 1 and the method 300 in FIG. 3.

FIG. 3 illustrates a route request processing method 300, performed in accordance with one or more embodiments. According to various embodiments, the method 300 may be performed on any suitable computing device. For example, the method 300 may be performed by one or more components in the computing services environment 200 shown in FIG. 2.

A request is received at 302 to determine routing information for a user. In some embodiments, the request may be received via an application procedure interface and may indicate a desire to determine routing information for physically moving from the initial geographic location to the terminal geographic location. For instance, the initial and terminal geographic locations may be different locations within a city, country, or other geographic region. As one example, a route request may be formatted as follows:
route_request object{
   “start_location”: {“latitude”: 37.616552, “longitude”: −122.390303},
   “end_location”: {“latitude”: 37.789778, “longitude”: −122.396944},
   “avoid_tolls”: false,
   “avoid_highways”: false}

According to various embodiments, the routing request may be received and/or processed in one or more of a variety of types of computing devices. For example, the request me be received on a mobile computing device associated with the user such as a mobile phone for on-the-edge processing. As another example, the request may be received on one or remote computing devices for on-the-cloud processing.

According to various embodiments, the routing request may be processed by one or more systems for security verification. For example, the routing request may be processed to authenticate to a user account. As another example, the routing request may be checked to validate the initial and/or terminal points of the route request. Additional details regarding route request caching and/or security validation are discussed with respect to FIG. 8A and FIG. 8B.

The source location for the user is identified at 304. In some configurations, the source location may be included in the request received at 302. Alternatively, the source location may be identified based on further communication. For instance, the computing services environment may communicate with a device associated with the user to determine geolocation information associated with the device.

The destination location for the user is identified at 306. In some embodiments, the destination location may be included in the request received at 302. For instance, the user may explicitly specify a destination location. Alternatively, the destination location may be determined via another mechanism. For instance, one or more recommended destinations may be determined as part of the determination of the routing information at 314.

According to various embodiments, the initial and/or terminal geographic locations may be specified via geocoordinates such as latitude and longitude. Alternatively, or additionally, the initial and/or terminal geographic locations may be specified by another type of location identifier. For instance, one or both locations may be identified by name (e.g., Salesforce Tower).

Telemetry data is identified at 308. According to various embodiments, the telemetry data at 308 may include information from one or more devices associated with the user, such as a vehicle and/or a mobile computing device. Such information may be used to facilitate the determination of a response to the routing request. Examples of telemetry data may include, but are not limited to, time-varying data about device location, velocity, acceleration, and orientation. Such information may be used, for instance, to infer whether a user is driving, walking, or stationary. Additional details regarding operations performed using the telemetry data are discussed with respect to the method 400 shown in FIG. 4.

One or more database records related to the user account are retrieved from the database system at 310. According to various embodiments, the one or more database records may include any information suitable for facilitating the determination of routing information in response to the request. For example, the one or more database records may include implicitly determined and/or explicitly specified user preference data. As another example, the one or more database records may include previously provided routing information and/or feedback provided by the user in response to previously provided routing information. As yet another example, the one or more database records may include previously determined telemetry data collected for a vehicle or device associated with the user.

One or more route determination parameters are identified at 312. According to various embodiments, route determination parameters may include any information that may be used to determining routing information. For example, the request received at 302 may include a request to avoid highways, avoid tolls, identify the fastest route, avoid inclement weather, avoid traffic congestion, pass by one or more points of interest, or the like.

According to various embodiments, route determination parameters may be determined by any of a variety of techniques. For example, one or more route determination parameters may be explicitly specified by the user. Such specification may occur in the request received at 302. Alternatively, or additionally, such specification may be reflected in the one or more database records retrieved at 310. As another example, one or more route determination parameters may be determined based on implicit user preferences reflected in the database records retrieved at 310, for instance based on feedback previously provided by the user.

In some embodiments, route determination parameters may be determined based on one or more database records stored in the database system 200. For example, some or all of the registered user's preference records and/or historical routing records may be retrieved and considered when determining routing parameters. Then, such parameters may be used for operations such as determining candidate routes, selecting between candidate routes, and/or determining supplemental routing information.

According to various embodiments, database records may also be gathered based on heuristics insights identified by artificial intelligence. For example, if the routing system receives data about the terminal endpoint being an address of a customer as indicated in CRM data, a route parameter may be added to include options relevant to the associated client in the CRM data. As another example, a route parameter may be added to include an associated client's preferences as indicated in the CRM data.

According to various embodiments, route determination parameters may be determined on any of a variety of computing devices. For example, routing parameters may be determined on the mobile device requesting the geographic routing. For instance, the user may request a route from a mobile device and include route-based parameters that may include a prompt to suggest a route for a 5-mile run that avoids traffic and includes some hills. The navigation system may use one or more API services to aid with the determination of a route. As another example, routing parameters may be determined by any component of the computing services environment 200. Additional details regarding operations performed using the routing parameters are discussed with respect to the method 400 shown in FIG. 4.

Routing information for the user is determined at 314. According to various embodiments, determining the routing information may involve identifying one or more candidate routes, selecting between the candidate routes, and/or determining supplemental routing information. Additional details regarding the determination of the routing information are discussed with respect to the method 400 shown in FIG. 4.

The routing information is transmitted to the client machine at 316. In some embodiments, the routing information may include an instruction to present some or all of the routing information at a user interface at the client machine. For instance, the routing information may be displayed as a route overlay on a map, as graphical and/or audible turn-by-turn instructions, as one or more points of interest on a map, as a description of one or more points of interest, or the like. The particular way in which the routing information is presented may depend in significant part on the configuration of nature of the client machine.

A determination is made at 318 as to whether to determine additional routing information. In some embodiments, the routing request may be treated as a singular request, and additional routing information need not be determined. Alternatively, the routing information may be updated, for instance as additional telemetry data for the user is received. For example, the routing information may be updated as a user moves through geographic space so as to provide new information that reflects a user's updated position.

According to various embodiments, the navigation system may use a combination of cameras, GPS location, audio, and/or prompt text to answer questions the user may have during the route. For example, the user may inquire as to the identity and/or nature of an area of interest (e.g., statue, bridge, park, school), and the navigation system may return an answer that describes the area of interest based on available input information at the time of the request. As another example, the user may ask why one or more points of interest or route elements were included. For instance, if the user suggests visiting a restaurant, the navigation system may suggest visiting an Italian restaurant. If the user asks the navigation system why it included an Italian restaurant, the navigation system may respond that the Italian restaurant was suggested based on the users' preference data.

FIG. 4 illustrates a user route determination method 400, performed in accordance with one or more embodiments. According to various embodiments, determining the routing information may involve identifying one or more candidate routes, selecting between the candidate routes, and/or determining supplemental routing information.

A request to determine one or more routes from a source destination to a target destination is received at 402. In some embodiments, the request may contain the starting geographical location 304, terminal geographical location 306, identified telemetry data 308, one or more database records 310, and one or more route determination parameters 312 to aid with the route determination process. For example, the route determination request may contain a parameter to find a route that minimized the total route time.

A route query is determined at 404. In some embodiments, additional data such as one or more routing parameters may be included to generate a route query. For example, a route query may be determined by including one or more routing parameters at 312 based on the received request at 402.

A route query is transmitted to a geographic routing engine at 406. In some embodiments, the geographic routing engine 222 may route the request to a specified geographic routing engine (e.g., Google Maps). For instance, the specific geographic routing engine may be identified via a routing parameter.

One or more candidate routes are received at 408 from the geographic routing engine 222. In some embodiments, the geographic routing engine 222 may return one or more candidate routes depending on a variety of metrics. For example, the route query may contain a routing parameter that specifies top n-number of routes to return. For another example, the geographic routing engine 222 may return one or more candidate routes along with their respective estimated drive time.

According to various embodiments, the geographic routing engine may also return additional relevant time series data that pertains to the associated routes. For example, the geographic routing engine may include non-routing data such as weather conditions and/or traffic conditions.

A determination is made at 410 as to whether to determine one or more additional candidate routes. According to various embodiments, the one or more additional candidate routes may be determined with one or more routing parameters 312. For example, a candidate route may be determined by looping over different route queries with different routing parameters.

One or more routes are selected at 412 for transmission to the client machine. In some embodiments, the route selection method may include determining an evaluation for the candidate routes relative order (e.g., Rank). For example, evaluating candidate routes by ranking them in ascending order of total driving time. Additional details regarding the route selection method are discussed with respect to the method 500 shown in FIG. 5.

FIG. 5 illustrates a user route selection method 500, performed in accordance with one or more embodiments. In various embodiments, the route selection method may use generative language models to aid with the selection step.

A request to select one or more candidate routes is received at 502. According to various embodiments, one or more candidate routes are selected by either selecting one or more candidate routes generated at 412 and/or supplementing with one or more candidate routes. In some embodiments, the number of routes selected may be passed in as a parameter in the route selection request. For example, the parameter that specifies the number of candidate routes to select may be a previously calculated generative language model tuning parameter.

One or more points of interest are identified at 504. According to various embodiments, the set of points of interest (POI) are identified by using variety of techniques. For example, one or more of the candidate routes may be provided to a POI interface that returns points of interest along the candidate routes. In some configurations, the POI interface may return information such as a description, an identifier, a name, and/or a location about the points of interest. The POI interface may receive as input routing information about a route, information identifying a geographic region, and/or one or more search criteria for identifying points of interest.

A route evaluation prompt is determined at 506 to submit to a generative language model. In some embodiments, the route evaluation prompt may include one or more explicitly and/or implicitly identified parameters. For example, the prompt may include parameters to evaluate a route based on the explicit instruction the user passed in (e.g., Avoid Tolls). For another example, the prompt may include an instruction to evaluate a route given the associated users' historical routes and route feedback records. As yet another example, prompt-engineering instructions may be added to the route evaluation prompt that specify the request to the generative language model also evaluate the route based on metrics and heuristics available to the generative language model.

In some embodiments, the route may be selected based at least in part on the one or more points of interest identified at operation 504. For example, the generate language model may be tasked with identifying which of the candidate routes, including the points of interest and associated information identified at 504, best matches with the initial request for routing information provided by the user, as supplemented based on information selected from the user account and/or other sources. The generative language model may be tuned to perform such tasks as discussed with respect to the method 600 shown in FIG. 6.

A route is selected at 508 from the one or more candidate routes. In some embodiments, the route is selected based on novel text generated by the generative language model via the route evaluation prompt. For example, the one or more candidate routes may be inputted to the generative language model along with the routing parameters and the route evaluation prompt, and the route evaluation model may determine which of the candidate routes best suits the required criteria based on the route evaluation model.

A navigation prompt is determined at 510 to submit to a generative language model. In some embodiments, the navigation prompt may be fully generated by the generative language model. According to various embodiments, the navigation prompt may include instructions relevant to the associated users' preference records 206 to create a custom model response. For example, the users' preference records may include a parameter indicating a level of verbosity for the directions and/or interactions. For another example, the user may indicate that he or she prefers to receive facts about the surrounding area until the user reaches the terminal location. As yet another example, the user may request to have the directions read to as a character from a movie, and the generative language model will create a response to accommodate the request.

Navigation instructions and supplemental route information are determined at 512 by the generative language model. In some embodiments, the navigation instructions and supplemental route information may be transmitted to a navigation application such as Google Maps, Apple Maps, Overture Maps, or any other interface for providing mapping, waypoints, and/or points of interest information. For instance, the navigation instructions may be implemented as a route complete with turn-by-turn instructions, while the supplemental route information may include one or more points of interest positioned along the route.

In some embodiments, the generative language model may also interface with speech synthesis models to generate the appropriate speech as requested by the user. For example, the user may request to have the directions read as a character from a movie, and the generative language model will create a response that integrates parts of the character into the contents of the speech and/or navigation instructions and mimics voice of the character.

FIG. 6 illustrates a generative language model route tuning method 600, performed in accordance with one or more embodiments. Tuning the generative language model for routing may occur at any time. For example, the request to tune a generative language model for routing may be triggered if sufficient candidate routes are deemed insufficient. As another example, the generative language model may be tuned periodically or upon request.

A request to tune a generative language model for routing is received at 602. The request may include data from one or more sources to tune the generative language model. For example, the request may include one or more database records from the database system 202. For another example, the request may also include supplemental details to improve the tuning itself, such as improvements suggested from previous historical routing records 204.

The tuning data for the generative language model is identified at 604. In some embodiments, the tuning data may include one or more parameters provided when executing the generative language model to generate novel text in response to requests for routing information. For instance, the tuning data may include one or more tuning parameters determined in a previous iteration of the method 600. Alternatively, or additionally, the tuning data may include default tuning data, for instance if the method 600 has not yet been run.

One or more routing queries provided to the generative language model are identified at 606. In some embodiments, the routing queries are determined by retrieving historical data stored in the database system 202. For example, the routing queries may include previously determined routing query data stored in the database system 202.

Routing information produced by the generative language model is identified at 608. The routing information is identified by one or more techniques. In some embodiments, the routing information is determined by including historical data stored in the database system 202.

Feedback information provided for the routing information is identified at 610. One or more techniques are used to identify feedback information. In some embodiments, the feedback information is determined by including historical data stored in the database system 202. For example, the feedback information may include previously identified feedback information stored in the database system 202.

According to various embodiments, the feedback information may be identified by a generative language model. For example, inputting any relevant historical data, along with the route, route feedback, and route queries to a generative language model, may return a representation of the route feedback. For another example, sentiment analysis may be used to identify route feedback metadata. As yet another example, a human-in-the-loop technique may also be used to identify feedback information. For instance, a human reviewer may provide feedback as to the quality and suitability of the routing information.

At 612, the routing information is compared to the route feedback information. According to various embodiments, comparing the routing information and route feedback information may involve one or more comparison functions. Such functions may involve additional calls to the generative language model. For example, the generative language model may evaluate the quality of the routing information based on the route feedback information.

In some embodiments, the users' historical feedback information may be aggregated and compared to the feedback information of 612. For example, sentiment analysis may be used to extract the sentiment of feedback provided for historical routes and compared with the feedback provided for more recent routes to aid the tuning process.

At 614, a determination is made as to whether to update the tuning data. In some embodiments, the comparison between the routing information to the feedback information of 612 may be used to determine the update criteria. For example, the tuning data may require further tuning if the comparison determined at 612 suggests updating the tuning data. In some embodiments, artificial intelligence models may be used to determine whether to update the tuning data. For example, a generative language model may be given access to relevant information and prompted to determine if updating the tuning data may result in better results.

The tuning data is updated at 616. In some embodiments, incremental updates to the tuning data may improve the routing information generated by the generative language model. For example, routing information generated by the generative language model may be improved by using updating the routing parameters to swap a set of words with their respective synonyms.

The tuning data is stored at 618 in the database system 202. In some embodiments, the stored tuning data may be used for tuning a generative language model. For example, information generated during the route tuning method may be stored and later used for processing requests sent to the generative language model.

FIG. 7 shows a block diagram of an example of an environment 710 that includes an on-demand database service configured in accordance with some implementations. Environment 710 may include user systems 712, network 714, database system 716, processor system 717, application platform 718, network interface 720, tenant data storage 722, tenant data 723, system data storage 724, system data 725, program code 726, process space 728, User Interface (UI) 730, Application Program Interface (API) 732, PL/SOQL 734, save routines 736, application setup mechanism 738, application servers 750-1 through 750-N, system process space 752, tenant process spaces 754, tenant management process space 760, tenant storage space 762, user storage 764, and application metadata 766. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 716, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 718 may be a framework that allows the creation, management, and execution of applications in system 716. Such applications may be developed by the database service provider or by users or third-party application developers accessing the service. Application platform 718 includes an application setup mechanism 738 that supports application developers' creation and management of applications, which may be saved as metadata into tenant data storage 722 by save routines 736 for execution by subscribers as one or more tenant process spaces 754 managed by tenant management process 760 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 766 for a subscriber making such an invocation. Such system processes may also manage execution of application metadata 766 as an application in a virtual machine.

In some implementations, each application server 750 may handle requests for any user associated with any organization. A load balancing function (e.g., an F5 Big-IP load balancer) may distribute requests to the application servers 750 based on an algorithm such as least-connections, round robin, observed response time, etc. Each application server 750 may be configured to communicate with tenant data storage 722 and the tenant data 723 therein, and system data storage 724 and the system data 725 therein to serve requests of user systems 712. The tenant data 723 may be divided into individual tenant storage spaces 762, which can be either a physical arrangement and/or a logical arrangement of data. Within each tenant storage space 762, user storage 764 and application metadata 766 may be similarly allocated for each user. For example, a copy of a user's most recently used (MRU) items might be stored to user storage 764. Similarly, a copy of MRU items for an entire tenant organization may be stored to tenant storage space 762. A UI 730 provides a user interface and an API 732 provides an application programming interface to system 716 resident processes to users and/or developers at user systems 712.

System 716 may implement a web-based geographic routing system. For example, in some implementations, system 716 may include application servers configured to implement and execute software applications for geographic routing. The application servers may be configured to provide related data, code, forms, web pages and other information to and from user systems 712. Additionally, the application servers may be configured to store information to, and retrieve information from a database system. Such information may include related data, objects, and/or Webpage content. With a multi-tenant system, data for multiple tenants may be stored in the same physical database object in tenant data storage 722, however, tenant data may be arranged in the storage medium(s) of tenant data storage 722 so that data of one tenant is kept logically separate from that of other tenants. In such a scheme, one tenant may not access another tenant's data, unless such data is expressly shared.

Several elements in the system shown in FIG. 7 include conventional, well-known elements that are explained only briefly here. For example, user system 712 may include processor system 712A, memory system 712B, input system 712C, and output system 712D. A user system 712 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 712 to access, process and view information, pages and applications available from system 716 over network 714. Network 714 may be any network or combination of networks of devices that communicate with one another, such as any one or any combination of a LAN (local area network), WAN (wide area network), wireless network, or other appropriate configuration.

The users of user systems 712 may differ in their respective capacities, and the capacity of a particular user system 712 to access information may be determined at least in part by “permissions” of the particular user system 712. As discussed herein, permissions generally govern access to computing resources such as data objects, components, and other entities of a computing system, such as a geographic routing system, a social networking system, and/or a CRM database system. “Permission sets” generally refer to groups of permissions that may be assigned to users of such a computing environment. For instance, the assignments of users and permission sets may be stored in one or more databases of System 716. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 716 may provide on-demand database service to user systems 712 using an MTS arrangement. By way of example, one tenant organization may be a company that employs a sales force where each salesperson uses system 716 to manage their sales process. Thus, a user in such an organization may maintain contact data, leads data, customer follow-up data, performance data, goals and progress data, etc., all applicable to that user's personal sales process (e.g., in tenant data storage 722). In this arrangement, a user may manage his or her sales efforts and cycles from a variety of devices, since relevant data and applications to interact with (e.g., access, view, modify, report, transmit, calculate, etc.) such data may be maintained and accessed by any user system 712 having network access.

When implemented in an MTS arrangement, system 716 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 716 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 716 may also maintain system-level data usable by multiple tenants or other data. Such system-level data may include industry reports, news, postings, and the like that are sharable between tenant organizations.

In some implementations, user systems 712 may be client systems communicating with application servers 750 to request and update system-level and tenant-level data from system 716. By way of example, user systems 712 may send one or more queries requesting data of a database maintained in tenant data storage 722 and/or system data storage 724. An application server 750 of system 716 may automatically generate one or more SQL statements (e.g., one or more SQL queries) that are designed to access the requested data. System data storage 724 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 8A shows a system diagram of an example of architectural components of an on-demand database service environment 800, configured in accordance with some implementations. A client machine located in the cloud 804 may communicate with the on-demand database service environment via one or more edge routers 808 and 812. A client machine may include any of the examples of user systems 712 described above. The edge routers 808 and 812 may communicate with one or more core switches 820 and 824 via firewall 816. The core switches may communicate with a load balancer 828, which may distribute server load over different pods, such as the pods 840 and 844 by communication via pod switches 832 and 836. The pods 840 and 844, which may each include one or more servers and/or other computing resources, may perform data processing and other operations used to provide on-demand services. Components of the environment may communicate with a database storage 856 via a database firewall 848 and a database switch 852.

Accessing an on-demand database service environment may involve communications transmitted among a variety of different components. The environment 800 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 8A and 8B.

The cloud 804 refers to any suitable data network or combination of data networks, which may include the Internet. Client machines located in the cloud 804 may communicate with the on-demand database service environment 800 to access services provided by the on-demand database service environment 800. By way of example, client machines may access the on-demand database service environment 800 to retrieve, store, edit, and/or process geographic routing information.

In some implementations, the edge routers 808 and 812 route packets between the cloud 804 and other components of the on-demand database service environment 800. The edge routers 808 and 812 may employ the Border Gateway Protocol (BGP). The edge routers 808 and 812 may maintain a table of IP networks or ‘prefixes’, which designate network reachability among autonomous systems on the internet.

In one or more implementations, the firewall 816 may protect the inner components of the environment 800 from internet traffic. The firewall 816 may block, permit, or deny access to the inner components of the on-demand database service environment 800 based upon a set of rules and/or other criteria. The firewall 816 may act as one or more of a packet filter, an application gateway, a stateful filter, a proxy server, or any other type of firewall.

In some implementations, the core switches 820 and 824 may be high-capacity switches that transfer packets within the environment 800. The core switches 820 and 824 may be configured as network bridges that quickly route data between different components within the on-demand database service environment. The use of two or more core switches 820 and 824 may provide redundancy and/or reduced latency.

In some implementations, communication between the pods 840 and 844 may be conducted via the pod switches 832 and 836. The pod switches 832 and 836 may facilitate communication between the pods 840 and 844 and client machines, for example via core switches 820 and 824. Also or alternatively, the pod switches 832 and 836 may facilitate communication between the pods 840 and 844 and the database storage 856. The load balancer 828 may distribute workload between the pods, which may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848, which may act as a computer application firewall operating at the database application layer of a protocol stack. The database firewall 848 may protect the database storage 856 from application attacks such as structure query language (SQL) injection, database rootkits, and unauthorized information disclosure. The database firewall 848 may include a host using one or more forms of reverse proxy services to proxy traffic before passing it to a gateway router and/or may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

In some implementations, the database storage 856 may be an on-demand database system shared by many different organizations. The on-demand database service may employ a single-tenant approach, a multi-tenant approach, a virtualized approach, or any other type of database approach. Communication with the database storage 856 may be conducted via the database switch 852. The database storage 856 may include various software components for handling database queries. Accordingly, the database switch 852 may direct database queries transmitted by other components of the environment (e.g., the pods 840 and 844) to the correct components within the database storage 856.

FIG. 8B shows a system diagram further illustrating an example of architectural components of an on-demand database service environment, in accordance with some implementations. The pod 844 may be used to render services to user(s) of the on-demand database service environment 800. The pod 844 may include one or more content batch servers 864, content search servers 868, query servers 882, file servers 886, access control system (ACS) servers 880, batch servers 884, and app servers 888. Also, the pod 844 may include database instances 890, quick file systems (QFS) 892, and indexers 894. Some or all communication between the servers in the pod 844 may be transmitted via the switch 836.

In some implementations, the app servers 888 may include a framework dedicated to the execution of procedures (e.g., programs, routines, scripts) for supporting the construction of applications provided by the on-demand database service environment 800 via the pod 844. One or more instances of the app server 888 may be configured to execute all or a portion of the operations of the services described herein.

In some implementations, as discussed above, the pod 844 may include one or more database instances 890. A database instance 890 may be configured as an MTS in which different organizations share access to the same database, using the techniques described above. Database information may be transmitted to the indexer 894, which may provide an index of information available in the database 890 to file servers 886. The QFS 892 or other suitable filesystem may serve as a rapid-access file system for storing and accessing information available within the pod 844. The QFS 892 may support volume management capabilities, allowing many disks to be grouped together into a file system. The QFS 892 may communicate with the database instances 890, content search servers 868 and/or indexers 894 to identify, retrieve, move, and/or update data stored in the network file systems (NFS) 896 and/or other storage systems.

In some implementations, one or more query servers 882 may communicate with the NFS 896 to retrieve and/or update information stored outside of the pod 844. The NFS 896 may allow servers located in the pod 844 to access information over a network in a manner similar to how local storage is accessed. Queries from the query servers 822 may be transmitted to the NFS 896 via the load balancer 828, which may distribute resource requests over various resources available in the on-demand database service environment 800. The NFS 896 may also communicate with the QFS 892 to update the information stored on the NFS 896 and/or to provide information to the QFS 892 for use by servers located within the pod 844.

In some implementations, the content batch servers 864 may handle requests internal to the pod 844. These requests may be long-running and/or not tied to a particular customer, such as requests related to log mining, cleanup work, and maintenance tasks. The content search servers 868 may provide query and indexer functions such as functions allowing users to search through content stored in the on-demand database service environment 800. The file servers 886 may manage requests for information stored in the file storage 898, which may store information such as documents, images, basic large objects (BLOBs), etc. The query servers 882 may be used to retrieve information from one or more file systems. For example, the query system 882 may receive requests for information from the app servers 888 and then transmit information queries to the NFS 896 located outside the pod 844. The ACS servers 880 may control access to data, hardware resources, or software resources called upon to render services provided by the pod 844. The batch servers 884 may process batch jobs, which are used to run tasks at specified times. Thus, the batch servers 884 may transmit instructions to other servers, such as the app servers 888, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as variety of devices such as an application server, a database server, or any other device or service described herein. Although a particular configuration is described, a variety of alternative configurations are possible. The processor 901 may perform operations such as those described herein. Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of CRM applications. However, the techniques disclosed herein apply to a wide variety of applications that involve geographic routing. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A system comprising:
a database system storing a plurality of data records corresponding with a plurality of user accounts, the plurality of data records including historical routing information characterizing geographic routes determined in association with the plurality of user accounts;
a communication interface configured to receive a request from a remote computing device authenticated to a user account of the plurality of user accounts, the request identifying an initial geographic location and a terminal geographic location;
a geographic routing engine configured to determine a route from the initial geographic location to the terminal geographic location, the route including turn-by-turn instructions for moving from the initial geographic location to the terminal geographic location;
a generative language model interface configured to complete a navigation prompt to include novel text identifying supplemental route information, the navigation prompt including input route information determined based on the route, the navigation prompt including a natural language instruction to generate the novel text, the navigation prompt including user customization information determined based on the historical routing information; and
a user interface generation interface configured to transmit an instruction to the remote computing device to present a user interface that includes the turn-by-turn instructions and some or all of the supplemental route information.

2. The system recited in claim 1, wherein determining the route from the initial geographic location to the terminal geographic location comprises:
determining a plurality of candidate routes from the initial geographic location to the terminal geographic location; and
selecting the route from among the plurality of candidate routes based at least in part on one or more route evaluation parameters.

3. The system recited in claim 2, wherein selecting the route from among the plurality of candidate routes comprises:
transmitting a route evaluation prompt including candidate route information characterizing the plurality of routes to a generative language model; and
receiving an indication of the route from the generative language model.

4. The system recited in claim 3, wherein the candidate route information includes database record information selected from the plurality of data records, wherein route evaluation prompt further includes a route evaluation natural language instruction to select the route based at least in part on the database record information.

5. The system recited in claim 4, wherein the database record information includes preference information characterizing one or more preferences expressed by a user in association with the user account.

6. The system recited in claim 4, wherein the database record information includes user account routing information characterizing responses to previous routing requests submitted in association with the user account.

7. The system recited in claim 3, wherein the route evaluation prompt includes a natural language criterion for selecting a route received as user input in association with the request.

8. The system recited in claim 3, wherein the geographic routing engine is further configured to determine a plurality of points of interest associated with geographic locations along the plurality of candidate routes, and wherein the route is selected based in part on textual information characterizing the plurality of points of interest.

9. The system recited in claim 1, wherein the geographic routing engine is further configured to determine a plurality of points of interest associated with geographic locations along the route, and wherein the novel text includes text characterizing one or more of the plurality of points of interest.

10. The system recited in claim 1, wherein the request identifies one or more criteria for determining the route.

11. A method comprising:
retrieving from a database system one or more data records of a plurality of data records corresponding with a plurality of user accounts, the plurality of data records including historical routing information characterizing geographic routes determined in association with the plurality of user accounts;
receiving via a communication interface a request from a remote computing device authenticated to a user account of the plurality of user accounts, the request identifying an initial geographic location and a terminal geographic location;
determining a route from the initial geographic location to the terminal geographic location via a geographic routing engine, the route including turn-by-turn instructions for moving from the initial geographic location to the terminal geographic location;
completing a navigation prompt to include novel text identifying supplemental route information via a generative language model interface, the navigation prompt including input route information determined based on the route, the navigation prompt including a natural language instruction to generate the novel text, the navigation prompt including user customization information determined based on the historical routing information; and
transmitting an instruction to the remote computing device via a user interface generation interface to present a user interface that includes the turn-by-turn instructions and some or all of the supplemental route information.

12. The method recited in claim 11, wherein determining the route from the initial geographic location to the terminal geographic location comprises:
determining a plurality of candidate routes from the initial geographic location to the terminal geographic location; and
selecting the route from among the plurality of candidate routes based at least in part on one or more route evaluation parameters.

13. The one or more non-transitory computer readable media recited in claim 12, wherein selecting the route from among the plurality of candidate routes comprises:
transmitting a route evaluation prompt including candidate route information characterizing the plurality of routes to a generative language model; and
receiving an indication of the route from the generative language model.

14. The method recited in claim 13, wherein the candidate route information includes database record information selected from the plurality of data records, wherein route evaluation prompt further includes a route evaluation natural language instruction to select the route based at least in part on the database record information.

15. The method recited in claim 14, wherein the database record information includes preference information characterizing one or more preferences expressed by a user in association with the user account.

16. The method recited in claim 14, wherein the database record information includes user account routing information characterizing responses to previous routing requests submitted in association with the user account.

17. The method recited in claim 13, wherein the route evaluation prompt includes a natural language criterion for selecting a route received as user input in association with the request.

18. One or more non-transitory computer readable media having instructions stored thereon for performing a method, the method comprising:
retrieving from a database system one or more data records of a plurality of data records corresponding with a plurality of user accounts, the plurality of data records including historical routing information characterizing geographic routes determined in association with the plurality of user accounts;
receiving via a communication interface a request from a remote computing device authenticated to a user account of the plurality of user accounts, the request identifying an initial geographic location and a terminal geographic location;
determining a route from the initial geographic location to the terminal geographic location via a geographic routing engine, the route including turn-by-turn instructions for moving from the initial geographic location to the terminal geographic location;
completing a navigation prompt to include novel text identifying supplemental route information via a generative language model interface, the navigation prompt including input route information determined based on the route, the navigation prompt including a natural language instruction to generate the novel text, the navigation prompt including user customization information determined based on the historical routing information; and
transmitting an instruction to the remote computing device via a user interface generation interface to present a user interface that includes the turn-by-turn instructions and some or all of the supplemental route information.

19. The one or more non-transitory computer readable media recited in claim 18, wherein determining the route from the initial geographic location to the terminal geographic location comprises:
determining a plurality of candidate routes from the initial geographic location to the terminal geographic location; and
selecting the route from among the plurality of candidate routes based at least in part on one or more route evaluation parameters.

20. The one or more non-transitory computer readable media recited in claim 19, wherein selecting the route from among the plurality of candidate routes comprises:
transmitting a route evaluation prompt including candidate route information characterizing the plurality of routes to a generative language model; and
receiving an indication of the route from the generative language model.
